(19) United States
(12) Patent Application Publication
(10) Pub. No.: US 2002/0065687 A1
(43) Pub. Date: May 30, 2002

(54) System for processing insurance benefit agreements and computer readable medium storing a program therefor

(75) Inventor: Masashi Onoue, Tokyo (JP)

Correspondence Address: BURR & BROWN, PO BOX 7068, SYRACUSE, NY, 13261-7068, US

(73) Assignee: Tsubasa System Co., Ltd.

(21) Appl. No.: 09/728,820

(22) Filed: Nov. 30, 2000

(51) Int. Cl. G06F 17/60

(52) U.S. Cl. 705/4

(57) ABSTRACT

The present invention relates to a system for processing insurance benefit agreements for providing automobile insurance against loss for damaged cars, consisting of a first computer that is used by a repairer who repairs damaged cars, and a second computer that is connected to the first computer via a communication channel and used by an automobile insurance company, wherein the first computer comprises data inputting means, repair expenses estimation data generating means, first transmitting means for transmitting agreement data to the second computer, and first receiving means for receiving agreement determination data from the second computer, and the second computer comprises second receiving means for receiving the agreement data from the first computer, second storing means, payment standard for repairers determining means, and second transmitting means. In accordance with the present invention, since accident investigation conventionally conducted by an adjuster is unnecessary, costs of an insurance company can be reduced and insurance products with low insurance premiums can be established.

### BACKGROUND OF THE INVENTION

1. Field of the Invention

The present invention relates to a system for processing insurance benefit agreements for providing automobile insurance against loss for damaged vehicles.

2. Description of the Related Art

In order to have insurance money of an automobile insurance against loss paid for repairs of a damage car, a repairer of the car estimates repair expenses and a non-life insurance company (hereinafter referred to as an “insurance company”) must agree to the estimate determining that it is appropriate. Such an agreement is generally called an insurance agreement.

An estimation apparatus has been proposed that utilizes a computer with respect to the above-mentioned estimate of repair expenses for a damaged car by the repairer, and it is becoming possible to prepare an estimate for repair expenses with high objectivity and reliability in a short time.

On the other hand, an insurance company has been making an adjuster to investigate an accident and damage conditions of a damaged car and the like to determine whether the estimate prepared by the repairer is appropriate based on a report from the adjuster.

However, the above-mentioned conventional estimation apparatus has such problems as follows. That is, since a period of at least a few days is necessary including an investigation period required by the adjuster in order to conclude the above-mentioned agreement, there is a problem that repair of the damaged car cannot be commenced during that period. In addition, it is necessary to confirm the intention of the owner of the damaged car as well based on results of the insurance agreement.

Further, costs required for the above-mentioned investigation by the adjuster causes increase of expenses, which makes it difficult to decrease expenses of the insurance company. Therefore, although it is necessary to decrease insurance premiums in view of intensifying competitions in the non-life insurance industry due to deregulation of insurance premiums and the like in line with such as the recent financial liberalization for competition, there has been a limit for insurance companies to decrease insurance premiums.

Moreover, since conditions set from the standpoint of the insurance company side are indiscriminately established as a payment standard concerning insurance benefits (payment of insurance money, provision of services and the like), automobile owners (policyholders) are often dissatisfied with payments.

Thus, it is considered necessary, for insurance companies to maintain and acquire customers, to abolish such a custom and strengthen cooperative relationship between insurance companies and automobile repairers having excellent technical and commercial abilities by establishing a payment standard that is acceptable for the three parties; insurance companies, repairers and policyholders.

### SUMMARY OF THE INVENTION

A first aspect of the present invention is an insurance benefit agreement processing system comprising a first computer for use by a repairer repairing a damaged vehicle and a second computer for use by an automobile insurance company that is connected to the first computer via a communication channel, wherein the first computer comprises: data inputting means; repair expenses estimation data generating means; first transmitting means for transmitting agreement data to the second computer; and first receiving means for receiving agreement determination data from the second computer, and the second computer comprises: second receiving means for receiving the agreement data from the first computer; second storing means; payment standard for repairers determining means; and second transmitting means.

The data inputting means inputs image data of a damaged vehicle, vehicle type specifying data for specifying a type of the damaged vehicle, damaged part data for specifying damaged parts, and damage degree data for specifying a damaged degree (a damage level)

The repair expenses estimation data generating means generates repair expenses estimation data based on the image data, the vehicle type specifying data, and the damaged part data inputted by the data inputting means.

The agreement data consists of the image data, vehicle type specifying data, and the damaged part data inputted by the data inputting means, as well as the repair expenses estimation data generated by the repair expenses estimation data generating means.

The agreement determination data indicates whether or not the agreement data transmitted to the second computer by the first transmitting means is appropriate.

The second storing means stores a payment conditions for repairers database regulating a payment standard for the repairer who uses the first computer.

The payment standard for repairers determining means determines whether or not the agreement data received by the second receiving means is appropriate in light of the payment conditions for repairers database stored in the second storing means.

The second transmitting means transmits data indicating results determined by the payment standard for repairers determining means to the first computer.

In addition, a second aspect of the present invention is an insurance benefit agreement processing system comprising a first computer for use by a repairer repairing a damaged vehicle and a second computer for use by an automobile insurance company that is connected to the first computer via a communication channel, wherein the first computer comprises: data inputting means; first repair expenses estimation data generating means; first transmitting means for transmitting agreement data to the second computer; damage inappropriate data receiving means; repair expenses estimation inappropriate data receiving means; payment standard inappropriate data receiving means; and payment standard appropriate data receiving means, and the second computer comprises: receiving means for receiving the agreement data from the first computer; displaying means for displaying images; display instructing means; second storing means; damage determination data inputting means; damage inappropriate data transmitting means; second repair expenses estimation data generating means; repair expenses estimation data comparing means; repair expenses estimation inappropriate data transmitting means; payment standard for repairers determining means; payment standard inappropriate data transmitting means; and payment standard appropriate data transmitting means.

The data inputting means inputs image data of a damaged vehicle, the vehicle type specifying data for specifying a type of the damaged vehicle, damaged part data for specifying damaged parts, and damage degree data for specifying a damaged degree.

The first repair expenses estimation data generating means generates first repair expenses estimation data based on the image data, vehicle type specifying data, and the damaged part data inputted by the data inputting means.

The agreement data consists of the image data, vehicle type specifying data, the damaged part data, and the damage degree data inputted by the data inputting means, as well as the first repair expenses estimation data generated by the first repair expenses estimation data generating means.

The damage inappropriate data receiving means receives, if the damaged part data or the damage degree data inputted by the data inputting means is not appropriate, damage inappropriate data indicating to that effect from the second computer.

The repair expenses estimation inappropriate data receiving means receives, if the damaged part data and the damage degree data inputted by the data inputting means are appropriate but the first repair expenses estimation data generated by the first repair expenses estimation data generating means is not appropriate, repair expenses estimation inappropriate data indicating to that effect, from the second computer.

The payment standard inappropriate data receiving means receives, if the damaged part data and the damage degree data inputted by the data inputting means as well as the first repair expenses estimation data generated by the first repair expenses estimation data generating means are appropriate, but the first repair expenses estimation data generated by the first repair expenses estimation data generating means does not meet the payment standard for the repairer using the first computer, payment standard inappropriate data indicating to that effect and contents of the payment standard that is not met, from the second computer.

The payment standard appropriate data receiving means receives, if the damaged part data and the damage degree data inputted by the data inputting means as well as the first repair expenses estimation data generated by the first repair expenses estimation data generating means are appropriate, and the first repair expenses estimation data generated by the first repair expenses estimation data generating means meets the payment standard for the repairer using the first computer, payment standard inappropriate data indicating to that effect, from the second computer.

The display instructing means causes the display means to display images based on the agreement data received by the receiving means.

The second storing means stores a payment condition for repairers database regulating a payment standard for the repairer who uses the first computer.

The damage determining data inputting means inputs damage determination data indicating whether or not the damaged part data and the damage degree data in the agreement data received by the receiving means are appropriate.

The damage inappropriate data transmitting means transmits, if the damage determination data is the data indicating that the damaged part data and the damage degree data in the agreement data received by the receiving means are not appropriate, damage inappropriate data indicating to that effect to the first computer.

The second repair expenses estimation data generating means generates the second repair expenses estimation data based on the vehicle type specifying data, the damaged part data and the damage degree data in the agreement data received by the receiving means if the damage determination data is the data indicating that the damaged part data and the damage degree data in the agreement data received by the receiving means are appropriate.

The repair expenses estimation data comparing means compares the second repair expenses estimation data generated by the second repair expenses estimation data generating means with the first repair expenses estimation data in the agreement received by the receiving means, and determines whether the first repair expenses estimation data is appropriate.

The repair expenses estimation inappropriate data transmitting means transmits, if the first repair expenses estimation data is determined to be not appropriate by the repair expenses estimation data comparing means, repair expenses estimation inappropriate data notifying to that effect to the first computer.

The payment standard for repairers determining means determines whether or not contents of the first repair expenses estimation data meet the payment standard for the repairer using the first computer in light of the payment conditions for repairers database stored by the second storing means if the first repair expenses estimation data is determined to be appropriate by the repair expenses estimation data comparing means.

The payment standard inappropriate data transmitting means transmits, if the contents of the first repair expenses estimation data are determined not to meet the payment standard for the repairer using the first computer by the payment standard for repairers determining means, payment standard inappropriate data indicating to that effect and contents of the payment standard that is not met, to the first computer.

The payment standard appropriate data transmitting means transmits, if the contents of first repair expenses estimation data are determined to meet the payment standard for the repairer using the first computer by the payment standard for repairers determining means, payment standard appropriate data indicating to that effect to the first computer.

According to the present invention, since accident investigation conventionally conducted by an adjuster is unnecessary, costs of an insurance company can be reduced and insurance products with low insurance premiums can be established. In addition, since a payment standard can be flexibly set for each repairer, cooperative relationship between an insurance company and repairers can be easily maintained and reinforced. Moreover, since agreement is promptly concluded after estimation data is prepared and a repairer can commence repairs earlier, a net working rate of a repair shop can be increased.

Further, the first computer can comprise a first storing means for storing a payment conditions for insurance companies database regulating payment conditions for each insurance company using the second computer, and payment standard for insurance companies determining means for determining whether or not the repair expenses estimation data meets a payment standard for an insurance company to be another party of communication in light of the payment conditions for insurance companies database stored in the first storing means.

In this way, since a repairer can confirm the repair expenses estimation data in light of the payment standard of a particular insurance company (an insurance company to which an owner of a damaged vehicle requesting repairs holds a policy), expectation that the insurance expenses estimation data to be transmitted to the insurance company is accepted by the insurance company can be increased, and an insurance agreement can be concluded more rapidly.

In addition, since procedures until the conclusion of the insurance agreement can be easily grasped by both the computer of the repairer and the computer of the insurance company, contents of the procedures can be explained to a policyholder (the owner of the damaged vehicle) accurately and easily.

Here, the communication channel is a general public line and the like, and the data inputting means and the damage determination data inputting means are a mouse, a keyboard and the like. In addition, the data inputting means includes data transmitting means and the like for transmitting data from photographing means such as a digital camera.

Further, the repair expenses estimation data generating means, the first repair expenses estimation data generating means, the second repair expenses estimation data generating means, the payment standard for repairers determining means, the payment standard for insurance companies determining means and the repair expenses estimation data comparing means are CPUs (Central Processing Units) and the like.

Moreover, the transmitting means, the first transmitting means, the second transmitting means, the receiving means, the first receiving means, the second receiving means, the damage inappropriate data receiving means, the repair expenses estimation inappropriate data receiving means, the payment standard inappropriate data receiving means, the payment standard appropriate data receiving means, the damage inappropriate data transmitting means, the repair expenses estimation inappropriate data transmitting means, the payment standard inappropriate data transmitting means and the payment standard appropriate data transmitting means are modems and the like.

Furthermore, the first storing means and the second storing means are hard discs and the like, the displaying means is a CRT (Cathode Ray Tube), a liquid crystal display and the like, and the display instructing means is a CRT controller and the like.

### BRIEF DESCRIPTION OF THE DRAWINGS

Other objects and advantages of the present invention will become apparent during the following discussion in conjunction with the accompanying drawings, in which:

FIG. 1 is a schematic illustration of an insurance benefit agreement processing system in accordance with an embodiment of the present invention;

FIG. 2 is a block diagram showing a circuit configuration of a repairer computer of FIG. 1;

FIG. 3 is a block diagram showing a circuit configuration of an insurance company computer of FIG. 1;

FIG. 4 is a flow chart showing control processing executed in a control unit of FIG. 2; and

FIG. 5 is a flow chart showing control processing executed in a control unit of FIG. 3.

### DETAILED DESCRIPTION OF THE PREFERRED EMBODIMENT

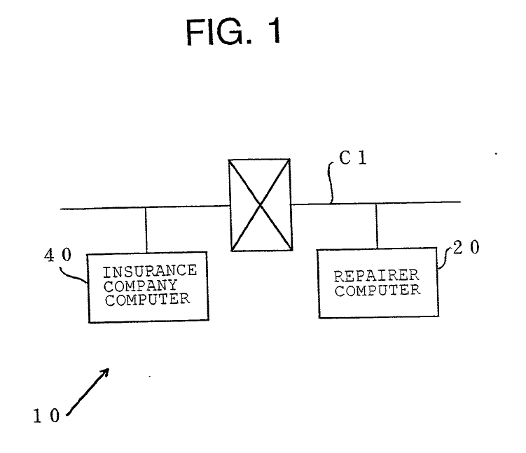

An embodiment of the present invention will now be described with reference to FIGS. 1 through 5.

FIG. 1 shows an insurance benefit agreement processing system 10 in accordance with the embodiment of the present invention. As shown in FIG. 1, the insurance benefit agreement processing system 10 is composed of a communication channel C1, and a repairer computer 20 and an insurance company computer 40 that are mutually connected via the communication channel C1. The communication channel C1 is a communication channel such as a public line network and a private line network. The repairer computer 20 is a personal computer and the like to be used by a repairer for a damaged car. In addition, the insurance company computer 40 is a personal computer and the like to be used by an automobile non-life insurance company.

The repairer computer 20 will now be described.

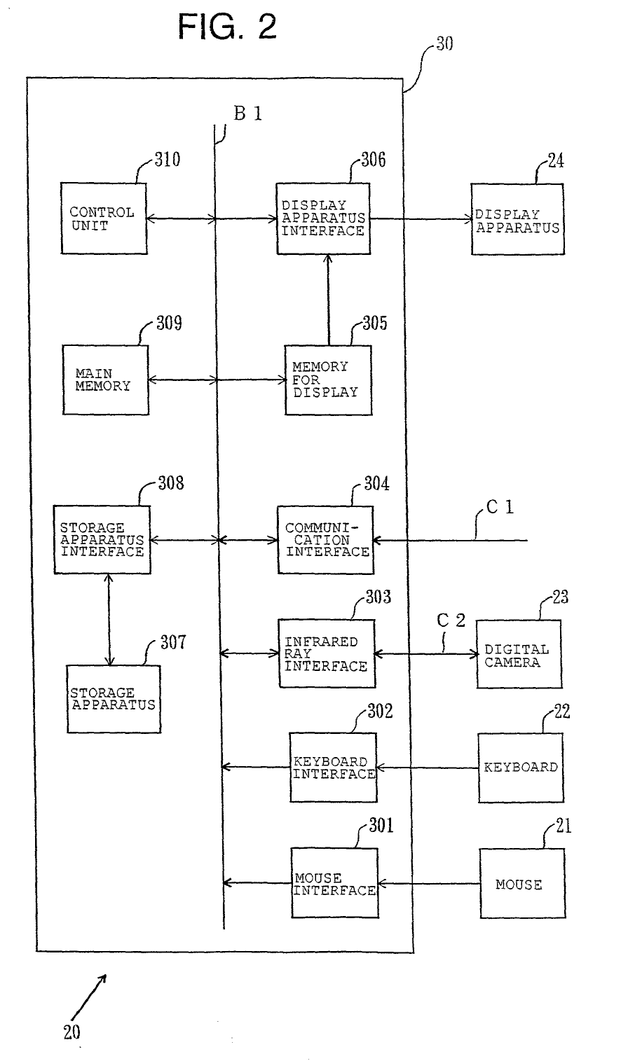

FIG. 2 shows a circuit configuration of the repairer computer 20. In FIG. 2, the repairer computer 20 is composed of a mouse 21, a keyboard 22, a digital camera 23, a display apparatus 24, and a computer main body 30. In addition, the computer main body 30 is composed of a mouse interface 301, a keyboard interface 302, an infrared ray interface 303, a communication interface 304, a memory for display 305, a display apparatus interface 306, a storage apparatus interface 308, a main memory 309 and a control unit 310 mutually connected via a bus B1, and a storage apparatus 307 connected to the bus B1 via the storage apparatus interface 308.

In addition, the mouse 21 is connected to the bus B1 via the mouse interface 301. The keyboard 22 is connected to the bus B1 via the keyboard interface 302. The display apparatus 24 is connected to the bus B1 via the display apparatus interface 306. Further, the digital camera 23 is connected to the bus B1 via the infrared ray interface 303 connected to the bus B1 and an infrared ray communication channel C2.

The mouse 21 and the keyboard 22 are apparatuses for an estimating personnel to perform input and the like of data. The mouse 21 and the keyboard 22 correspond to data inputting means.

The digital camera 23 is an apparatus for a repairer to acquire image data and the like of a damaged car. The digital camera 23 also corresponds to the data inputting means.

The display apparatus 24 is an apparatus for displaying an image of appearance of an automobile, characters and the like inputted by the keyboard 22.

In addition, the computer main body 30 is an apparatus for performing execution and the like of a program.

The mouse interface 301 is an apparatus for receiving data inputted by the estimating personnel from the mouse 21 and communicating the same to the bus B1.

The keyboard interface 302 is an apparatus for receiving data inputted by the estimating personnel from the keyboard 22 and communicating the same to the bus B1.

Moreover, the infrared ray interface 303 is an apparatus for receiving image data and the like of a damaged car from the digital camera 23 via the infrared ray communication channel C2, and communicating the same to the bus B1.

The communication interface 304 is an apparatus for receiving data from the communication channel C1 and communicating the same to the bus B1, and receiving data from the bus B1 and transmitting the same to the communication channel C1. The communication interface 304 corresponds to the transmitting means, the first transmitting means, the receiving means, the first receiving means, the damage inappropriate data receiving means, the repair expenses estimation inappropriate data receiving means, the payment standard inappropriate data receiving means and the payment standard appropriate data receiving means.

The memory for display 305 is composed of an RAM (Random Access Memory) and the like, and is a memory for holding data such as characters, images and the like to be displayed on the display apparatus 24.

The display apparatus interface 306 is an apparatus for causing the display apparatus 24 to display characters, images and the like.

The storage apparatus 307 is a hard disc apparatus for storing a program to be processed by the control unit 310, region data of an automobile, a payment conditions for insurance companies database for regulating the payment standard for insurance companies, and the like. The storage apparatus 307 corresponds to the first storing means.

The storage apparatus interface 308 is an apparatus for writing data in the storage apparatus 307 and reading data from the storage apparatus 307.

The main memory 309 is composed of an RAM and the like, and is a memory to be used for operation of the control unit 310.

The control unit 310 is composed of a CPU and the like, writes data such as characters, images and the like in the memory for display 305 and instructs the display apparatus interface 306 to perform screen display. In addition, the control unit 310 instructs the storage apparatus interface 308 to write data in the storage apparatus 307 and to read out data from the storage apparatus 307. Further, the control unit 310 receives inputted data from the mouse data 21 via the mouse interface 301, and receives inputted data from the keyboard 22 via the keyboard interface 302. Moreover, the control unit 310 performs processing of data such as characters inputted by the mouse 21 and the keyboard 22, and processing of screen data to be displayed on the display apparatus 24. Moreover, the control apparatus 310 receives data from the communication channel C1 via the communication interface 304, and transmits the same to the communication channel C1 via the communication interface 304. Furthermore, the control unit 310 receives image data from the digital camera 23 via the infrared ray interface 303 and the infrared ray communication channel C2. The control unit 310 corresponds to the repair expenses estimation data generating means, the first repair expenses estimation data generating means, and the payment standard for insurance companies determining means.

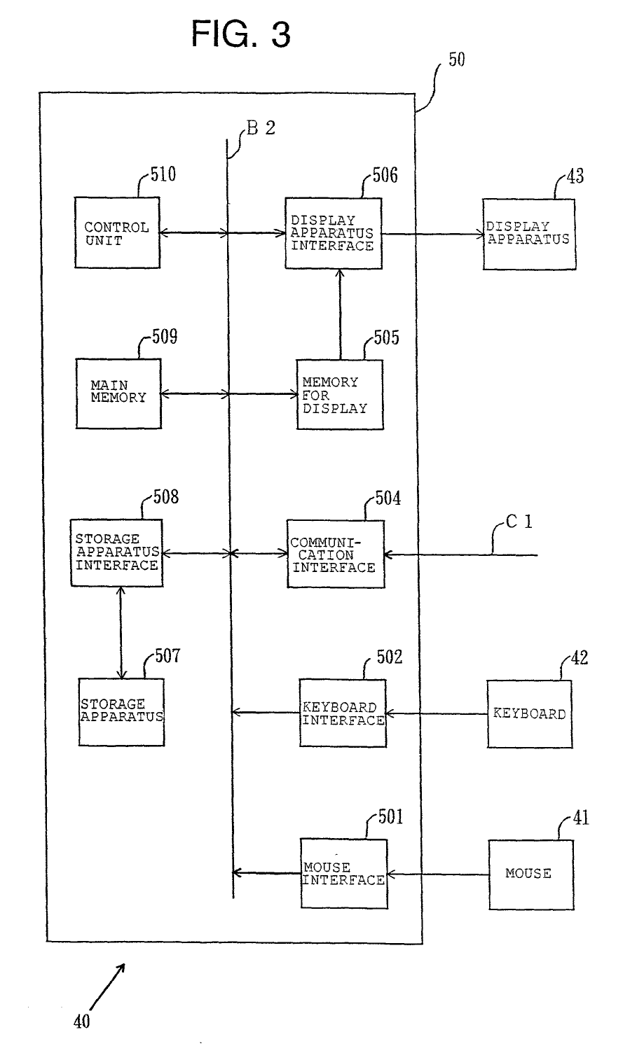

The insurance company computer 40 will now be described. FIG. 3 shows a circuit configuration of the insurance company computer 40.

In FIG. 3, the insurance company computer 20 is composed of a mouse 41, a keyboard 42, a display apparatus 43 and a computer main body 50.

In addition, the computer main body 50 is composed of a mouse interface 501, a keyboard interface 502, a communication interface 504, a memory for display 505, a display apparatus interface 506, a storage apparatus interface 508, a main memory 509 and a control unit 510 mutually connected via a bus B2, and a storage apparatus 507 connected to the bus B2 via the storage apparatus interface 508.

In addition, the mouse 41 is connected to the bus B2 via the mouse interface 501. The keyboard 42 is connected to the bus B2 via the keyboard interface 502. The display apparatus 43 is connected to the bus B2 via the display apparatus interface 506.

The mouse 41 and the keyboard 42 are apparatuses for an insurance assessing personnel to perform input and the like of data. The mouse 41 and the keyboard 42 correspond to the damage determining data inputting means.

The display apparatus 43 is an apparatus for displaying an image of appearance of an automobile, characters and the like inputted by the keyboard 42. The display apparatus 43 corresponds to the display means.

The computer main body 50 is an apparatus for performing execution and the like of a program.

The mouse interface 501 is an apparatus for receiving data inputted by the insurance assessing personnel from the mouse 41 and communicating the same to the bus B2.

The keyboard interface 502 is an apparatus for receiving data inputted by the insurance assessing personnel from the keyboard 42 and communicating the same to the bus B2.

The communication interface 504 is an apparatus for receiving data from the communication channel C1 and communicating the same to the bus B2, and receiving data from the bus B2 and transmitting the same to the communication channel C1. The communication interface 504 corresponds to the receiving means, the second receiving means, the second transmitting means, the repair expenses estimation inappropriate data transmitting means, the payment standard inappropriate data transmitting means and the payment standard appropriate data transmitting means.

The memory for display 505 is composed of an RAM (Random Access Memory) and the like, and is a memory for holding data such as characters, images and the like to be displayed on the display apparatus 43.

The display apparatus interface 506 is an apparatus for causing the display apparatus 43 to display characters, images and the like. The display apparatus interface 506 corresponds to the display instructing means.

The storage apparatus 507 is a hard disc apparatus for storing a program to be processed by the control unit 510, the repairer, a type of a damaged car, payment standard for repairers database and the like or regulating payment standards to repairers based on the repairing content. The storage apparatus 507 corresponds to the second storing means.

The storage apparatus interface 508 is an apparatus for writing data in the storage apparatus 507 and reading data from the storage apparatus 507.

The main memory 509 is composed of an RAM and the like, and is a memory to be used for operation of the control unit 510.

The control unit 510 is composed of a CPU and the like, writes data such as characters, images and the like in the memory for display 505, and instructs the display apparatus interface 506 to perform screen display. In addition, the control unit 510 instructs the storage apparatus interface 508 to write data in the storage apparatus 507 and to read out data from the storage apparatus 507. Further, the control unit 510 receives inputted data from the mouse data 41 via the mouse interface 501, and receives inputted data from the keyboard 42 via the keyboard interface 502. Moreover, the control unit 510 performs processing of data such as characters inputted by the mouse 41 and the keyboard 42, and processing of screen data to be displayed on the display apparatus 43. Furthermore, the control apparatus 510 receives data from the communication channel C1 via the communication interface 504, and transmits the same to the communication channel C1 via the communication interface 504. The control unit 510 corresponds to the payment standard for repairer determining means, the second repair expenses estimation data generating means, and the repair expenses estimation data comparing means.

<Description of operations of the embodiment>

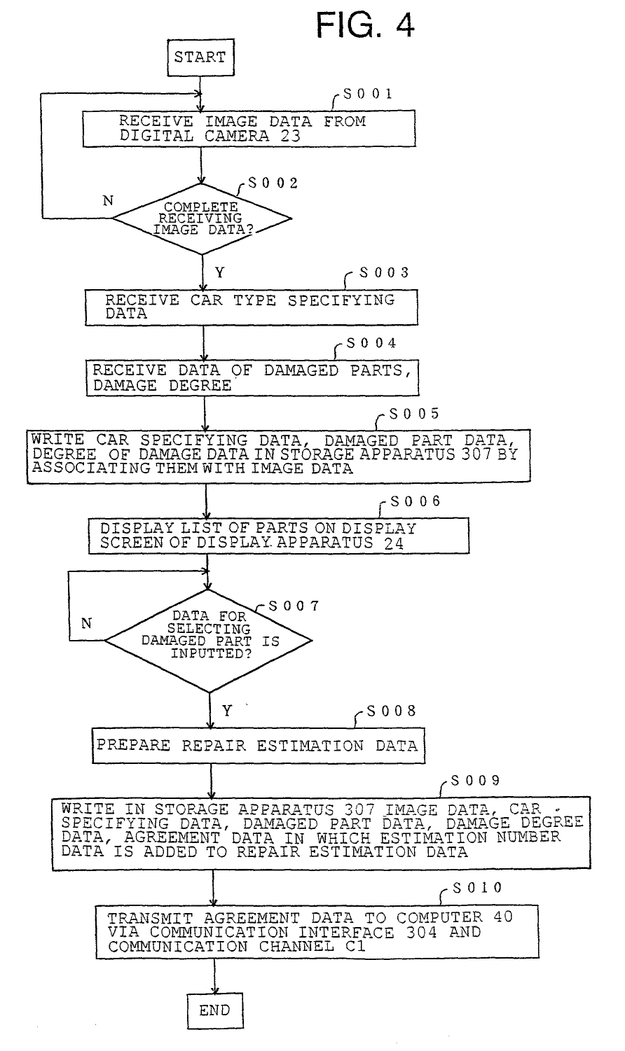

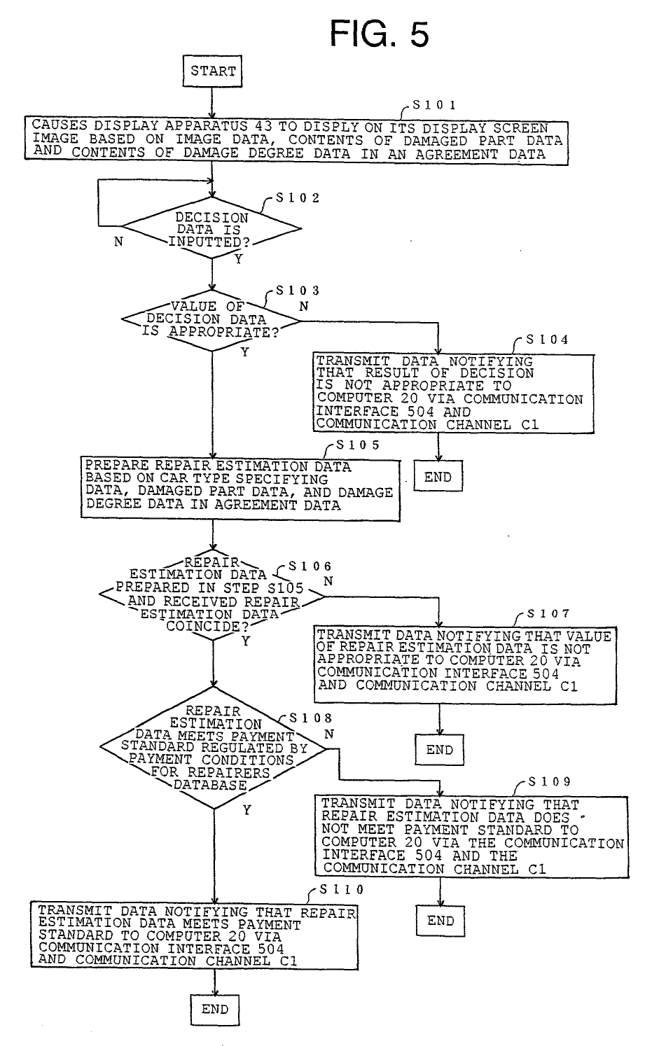

Contents of a control realized by the control unit 310 of the repairer computer 20 executing a program stored in the storage apparatus 307, and by the control unit 510 of the insurance company computer 40 executing a program stored in the storage apparatus 507 will now be described with reference to flow charts of FIGS. 4 and 5.

First, contents of a control realized by the control unit 310 of the repairer computer 20 executing a program stored in the storage apparatus 307 will now be described with reference to the flow chart of FIG. 4.

The control unit 310, when receiving instruction data instructing to commence repair expenses estimation job from the mouse 21 or the keyboard 22, starts a control shown in FIG. 4.

After starting the control, in the first step S001, the control unit 310 of the repairer computer 20 receives image data from the digital camera 23 via the infrared ray interface 303 and the infrared ray communication channel C2.

In the next step S002, the control unit 310 checks whether the reception of the image data has been completed or not. Then, if the reception of the image data has not been completed, the control unit 310 returns the processing to step S001, and if the reception of the image data is completed, the control unit 310 moves the processing to step S003.

If the control unit 310 determines in step S002 that the reception of the image data has been completed, it receives car type specifying data for specifying a type of a damaged car from the mouse 21 or the keyboard 22 in step S003.

In the next step S004, the control unit 310 receives damaged part data for specifying damaged parts of the damaged car and damage degree data specifying a damage degree from the mouse 21 or the keyboard 22. Further, the input of the damaged part data is performed by displaying an image based on the image data received in step S001 on the display screen of the display apparatus 24, and pointing a part corresponding to the damaged part in the displayed image by selecting an icon of circular, oval, rectangular shapes or the like that is closely similar to the damage shape.

In addition, the input of the damage degree data is performed by selectively inputting, for example, “large” if the damage extends to the inside of the damaged car, or “small” if only an outer plate panel is damaged.

In the next step S005, the control unit 310 writes the car type specifying data received in step S003, the damaged part data received in step S004, and the damage degree data received in step S004 in the storage apparatus 307 by associating them with the image data of the damaged car received in step S001.

In the next step S006, the control unit 310 reads out from the storage apparatus 307, data showing a list of regions of the damaged car specified by the car type specifying data received in step S003, and writes the data in the memory for display 305. In addition, the control unit 310 instructs the display apparatus interface 306 to display an image based on the data written in the memory for display 305 on the display screen of the display apparatus 24.

In the next step S007, the control unit 310 waits for data for selecting a damaged part of the damaged car out of the regions shown as a list on the display screen of the display apparatus 24 to be inputted from the mouse 21 or the keyboard 22. Further, the input of the data for selecting a damaged region is performed for each damaged part to be specified by the inputted damage part data among the images displayed on the display screen of the display apparatus 24 in step S004. When the data for selecting a damaged region of the damaged car is inputted from the mouse 21 or the keyboard 22, the control unit 310 moves the processing to step S008. In addition, a damaged region may be automatically selected and specified by the control unit 310 based on each of the data (the image data, the car type specifying data, the damaged part data, and the damage degree data).

If the data for selecting a damaged region of the damaged car is inputted in step S007, the control unit 310 prepares, in step S008, repair estimation data based on the car type specifying data inputted in step S003, the damage degree data inputted in step S004, and the damaged region data inputted in step S607.

In the next step S009, the control unit 310 prepares agreement data by adding estimation number data as a retrieval key to the image data received in step S001, the damaged part data and the damage degree data inputted in step S004, and the repair estimation data prepared in step S008. Then, the control unit 310 writes the prepared agreement data in the storage apparatus 307.

In next step S010, the control unit 310 transmits the agreement data prepared in step S009 to the insurance company computer 40 via the communication interface 304 and the communication channel C1. The control unit 310 thereafter completes the processing.

Contents of a control to be realized by the control unit 510 of the insurance company computer 40 executing a program stored in the storage apparatus 507 will now be described with reference to the flow chart of FIG. 5.

The control unit 510, when receiving the agreement data via the communication channel C1 and the communication interface 504, starts a control shown in FIG. 5.

After starting the processing, in the first step S101, the control unit 510 of the insurance company computer 40 causes the display apparatus 43 to display on its display screen an image based on the image data, the damaged part data and the damage degree data in the received agreement data.

In the next step S102, the control unit 510 waits for decision data showing whether the received agreement data is appropriate or not to be inputted by the mouse 41 or the keyboard 42. Here, the insurance assessing personnel decides whether or not the damaged part data and the damage degree data are appropriate based on the image data.

Then, if the decision data is inputted in step S102, the control unit 510 checks, in step S103, whether or not the decision data inputted in step S102 is data indicating that the received agreement data is appropriate. Then, if the decision data is not the data indicating that the agreement data is appropriate, the control unit 510 returns the processing to step S104, or otherwise moves the processing to step S105.

If the control unit 510 determines that the decision data is not the data indicating that the received agreement data is appropriate in step S103, it transmits data notifying that the result of the decision is not appropriate to the repairer computer 20 via the communication interface 504 and the communication channel C1 instep S104. The control unit 510 there after completes the processing.

On the other hand, if the control unit 510 determines that the decision data is the data indicating that the received agreement data is appropriate in step S103, it prepares repair estimation data based on the car type specifying data, the damaged part data, the damage degree data and the like in the agreement data in step S105. Further, the repair estimation preparing processing is the processing identical with the processing of step S008 executed by the control unit 310 of the repairer computer 20 as described above.

In the next step S106, the control unit 510 checks whether or not the repair estimation data in the received agreement data and the repair estimation data prepared in step S105 coincide. Then, if the control unit 510 determines that the repair estimation data in the received agreement data and the repair estimation data prepared in step S105 do not coincide, it moves the processing to step S107, and if it determines that both the data coincide, moves the processing to step S108. Further, in comparing the repair estimation data in the received agreement data and the repair estimation data prepared in step S105, determination is made depending on whether or not both the data are identical or substantially identical.

If the control unit 510 determines, in step S106, that the repair estimation data in the agreement data and the repair estimation data prepared in step S105 do not coincide, it transmits data notifying that the repair estimation data in the agreement data is not appropriate to the repairer computer 20 via the communication interface 503 and the communication channel C1 in step S107. The control unit 510 thereafter completes the processing.

On the other hand, if the control unit 510 determines, in step S106, that the decision data is the data indicating that the decision data is appropriate, in step S108, it checks whether or not the repair estimation data meets the payment standard regulated by the payment conditions for repairers database stored in the storage apparatus 507. Further, as example cases in which the payment standard is not met, there are such cases in which a lever rate is outside a predetermined range, an important safety part is not replaced but repaired, the higher of an estimated amount in a case of repair and an estimated amount in a case of part replacement is applied. Then, if the control unit 510 determines that the repair estimation data does not meet the payment standard regulated by the payment conditions for repairers database, it moves the processing to step S109, and if it determines that the payment standard is met, and moves the processing to step S110.

If the control unit 510 determines, in step S108, that the repair estimation data does not meet the payment standard regulated by the payment conditions for repairers database, it transmits data notifying that the repair estimation data does not meet the payment standard and contents of the payment standard that is not met (for example, that a lever rate is outside a predetermined range, etc.) to the repairer computer 20 via the communication interface 504 and the communication channel C1 in step S109. The control unit 510 thereafter completes the processing.

On the other hand, if the control unit 510 determines, in step S108, that the repair estimation data meets the payment standard regulated by the payment conditions for repairers database, it transmits data notifying that the repair estimation data meets the payment standard to the repairer computer 20 via the communication interface 504 and the communication channel C1 in step S110. When the data notifying that the repair estimation data meets the payment standard is transmitted to the repairer computer 20, an insurance agreement is considered to be concluded. The control unit 510 thereafter completes the processing.

Further, in inputting the car type specifying data, the damaged part data and the damage degree data in steps S003 and S004, data concerning a non-life insurance for the damaged car may be inputted simultaneously.

In addition, in step S007, the damaged region data of the damaged car may be automatically prepared by the control unit 310 instead of being inputted by an operator. As an example of automatic preparation of damaged region data, the control unit 310 of the repairer computer 20 may generate damaged region data by subjecting image processing to the image data of the damaged car and comparing image data of a specific car type stored in advance and the image data of the damaged car.

Further, in step S101 the control unit 510 of the insurance company computer 40 may generate decision data by subjecting image processing to the image data in the agreement data instead of the operator inputting the decision data specifying whether or not the agreement data is appropriate or not.

Moreover, in step S008 the repair expenses estimation data prepared by the control unit 310 of the repairer computer 20 may be compared with the payment conditions for insurance companies database regulating a payment standard for each insurance company stored in the storage apparatus 307 before being transmitted to the insurance company computer 40.

Furthermore, if the repair expenses estimation data prepared by the control unit 310 of the repairer computer 20 is compared with the payment conditions for insurance company database regulating the payment standard for the insurance company stored in the storage apparatus 307 before being transmitted to the insurance company computer 40, conclusion of an agreement is generally expected for agreement data to be transmitted, and more prompt and certain procedures for concluding an agreement can be carried out. In addition, a repairer can flexibly set insurance benefit conditions (a payment standard) for each of the different insurance companies.

In this way, since it is determined whether or not the repair expenses estimation data meets the payment standard in the computer used by the repairer before it is transmitted to the computer used by the insurance company from the computer used by the repairer, conclusion of an agreement is generally expected for the repair expenses estimation data transmitted from the computer used by the repairer to the computer used by the insurance company, and possibility of repeated consultations between the repairer and the owner of the damaged car caused by delayed conclusion of an agreement can be reduced.

Further, the term “region” used on this context represents a group of parts that have a certain uniformity relating to one identical part of an automobile. A certain uniformity may indicate a group of parts that are proximate to one part, or may be a group of parts that relate to each other when one part is repaired (for example, a group including parts that are required to be attached or detached when one part is repaired). In addition, one part may be one region.

This invention being thus described, it will be obvious that the same may be varied in various ways. Such variations are not to be regarded as departure from the spirit and scope of the invention, and all such modifications would be obvious for one skilled in the art intended to be included within the scope of the following claims.

What is claimed is:

1. An insurance benefit agreement processing system comprising a first computer for use by a repairer repairing a damaged vehicle and a second computer for use by an automobile insurance company that is connected to said first computer via a communication channel, wherein said first computer comprises:
data inputting means for inputting image data of a damaged vehicle, vehicle type specifying data for specifying a type of the damaged vehicle, damaged part data for specifying damaged parts, and damage degree data for specifying a damaged degree;
repair expenses estimation data generating means for generating repair expenses estimation data based on the image data, the vehicle type specifying data, and the damaged part data inputted by said data inputting means;
first transmitting means for transmitting to said second computer the agreement data consisting of the image data, the vehicle type specifying data, and the damaged part data inputted by said data inputting means, as well as the repair expenses estimation data generated by said repair expenses estimation data generating means; and
first receiving means for receiving from said second computer the agreement determination data indicating whether or not the agreement data transmitted to said second computer by said first transmitting means is appropriate, and
said second computer comprises:
second receiving means for receiving the agreement data from said first computer;
second storing means for storing a payment conditions for repairers database regulating a payment standard for the repairer who uses said first computer;
payment standard for repairers determining means for determining whether or not the agreement data received by said second receiving means is appropriate in light of the payment conditions for repairers database stored in said second storing means; and
second transmitting means for transmitting data indicating results determined by said payment standard for repairers determining means to said first computer.

2. An insurance benefit agreement processing system according to claim 1, wherein said first computer comprises first storing means for storing a payment conditions for insurance company database that regulates a payment standard for each insurance company using said second computer; payment standard for insurance companies determining means for determining whether or not the repair expenses estimation data meets a payment standard for an insurance company to be another party of communication in light of the payment conditions for insurance companies database stored in said first storing means.

3. An insurance benefit agreement processing system comprising a first computer for use by a repairer repairing a damaged vehicle and a second computer for use by an automobile insurance company that is connected to the first computer via a communication channel, wherein the first computer comprises:
data inputting means for inputting image data of a damaged vehicle, vehicle type specifying data for specifying a type of the damaged vehicle, damaged part data for specifying damaged parts, and damage degree data for specifying a damaged degree;
first repair expenses estimation data generating means for generating first repair expenses estimation data based on the image data, the vehicle type specifying data, and the damaged part data inputted by said data inputting means;
first transmitting means for transmitting to said second computer agreement data consisting of the image data, the vehicle type specifying data, the damaged part data, and the damage degree data inputted by said data inputting means, as well as the first repair expenses estimation data generated by said first repair expenses estimation data generating means;
damage inappropriate data receiving means for receiving, if the damaged part data or the damage degree data inputted by said data inputting means is inappropriate, damage inappropriate data indicating to that effect from the second computer;
repair expenses estimation inappropriate data receiving means for receiving, if the damaged part data and the damage degree data inputted by said data inputting means are appropriate but the first repair expenses estimation data generated by said first repair expenses estimation data generating means is not appropriate, repair expenses estimation inappropriate data indicating to that effect from said second computer;
payment standard inappropriate data receiving means for receiving, if the damaged part data and the damage degree data inputted by said data inputting means as well as the first repair expenses estimation data generated by said first repair expenses estimation data generating means are appropriate, but the first repair expenses estimation data generated by said first repair expenses estimation data generating means does not meet the payment standard for the repairer using said first computer, payment standard inappropriate data indicating to that effect and contents of the payment standard that is not met from said second computer; and
payment standard appropriate data receiving means for receiving, if the damaged part data and the damage degree data inputted by said data inputting means as well as the first repair expenses estimation data generated by said first repair expenses estimation data generating means are appropriate, and the first repair expenses estimation data generated by said first repair expenses estimation data generating means meets the payment standard for the repairer using said first computer, payment standard inappropriate data indicating to that effect from said second computer, and
the second computer comprises:
receiving means for receiving the agreement data from said first computer;
displaying means for displaying images;
display instructing means for causing said display means to display images based on the agreement data received by said receiving means;
second storing means for storing a payment conditions for repairers database regulating a payment standard for the repairer who uses said first computer;
damage determination data inputting means for inputting damage determination data indicating whether or not the damaged part data and the damage degree data in the agreement data received by said receiving means are appropriate;
damage inappropriate data transmitting means for transmitting, if the damage determination data is the data indicating that the damaged part data and the damage degree data in the agreement data received by said receiving means are not appropriate, damage inappropriate data indicating to that effect to said first computer;
second repair expenses estimation data generating means for generating second repair expenses estimation data based on the car type specifying data, the damaged part data and the damage degree data in the agreement data received by said receiving means if the damage determination data is the data indicating that the damaged part data and the damage degree data in the agreement data received by said receiving means are appropriate;
repair expenses estimation data comparing means for comparing the second repair expenses estimation data generated by said second repair expenses estimation data generating means with the first repair expenses estimation data in the agreement data received by said receiving means to determine whether the first repair expenses estimation data is appropriate;
repair expenses estimation inappropriate data transmitting means for transmitting, if the first repair expenses estimation data is determined to be not appropriate by said repair expenses estimation data comparing means, repair expenses estimation inappropriate data notifying to that effect to said first computer;
payment standard for repairers determining means for determining whether or not contents of the first repair expenses estimation data meet the payment standard for the repairer using said first computer in light of the payment conditions for repairers database stored by said second storing means if the first repair expenses estimation data is determined to be appropriate by said repair expenses estimation data comparing means.;
payment standard inappropriate data transmitting means for transmitting, if the contents of first repair expenses estimation data are determined not to meet the payment standard for the repairer using said first computer by said payment standard for repairers determining means, payment standard inappropriate data indicating to that effect and contents of the payment standard that is not met to said first computer; and
payment standard appropriate data transmitting means for transmitting, if the contents of first repair expenses estimation data are determined to meet the payment standard for the repairer using said first computer by said payment standard for repairers determining means, payment standard appropriate data indicating to that effect to said first computer.

4. An insurance benefit agreement processing system according to claim 3, wherein said first computer comprises first storing means for storing a payment conditions for insurance company database that regulates a payment standard for an insurance company using said second computer; payment standard for insurance companies determining means for determining whether or not the first repair expenses estimation data meets a payment standard for an insurance company to be another party of communication in light of the payment conditions for insurance companies database stored in said first storing means.

5. A computer readable medium storing a program for causing a first computer comprising data inputting means for inputting data, repair expenses estimation data generating means for generating repair expenses estimation data based on the inputted data, first transmitting means for transmitting data, and first receiving means for receiving data to:
input by said inputting means image data of a damaged vehicle, vehicle specifying data for specifying a vehicle type of the damaged vehicle, damaged part data for specifying damaged parts, and damage degree data for specifying a damage degree;
generate the repair expenses estimation data by said repair expenses estimation data generating means based on the image data, the car specifying data and the damaged part data inputted by said inputting means;
transmit to a second computer by said first transmitting means agreement data consisting of the image data inputted by said data inputting means, the vehicle specifying data, the damaged part data, as well as the repair expenses estimation data generated by said repair expenses estimation data generating means; and
receive data from said second computer by said first receiving means, and
for causing said second computer comprising second receiving means for receiving data, second transmitting means for transmitting data, second storing means for storing a payment conditions for repairer database regulating a payment standard of a repairer using said first computer, and payment standard for repairers determining means for determining whether the agreement data is appropriate or not to:
receive the agreement data from said first computer by said second receiving means;
determine by said payment standard for repairer determining means whether or not the agreement data received by said second receiving means is appropriate in light of the payment conditions for repairers database stored in said second storing means; and
transmit data indicating results determined by said payment standard for repairers determining means to said first computer by said second transmitting means.
